(19) United States
(12) Patent Application Publication
(10) Pub. No.: US 2025/0381853 A1
(43) Pub. Date: Dec. 18, 2025

(54) VEHICLE CONTROL DEVICE

(71) Applicant: SUBARU CORPORATION, Tokyo (JP)

(72) Inventor: Koji MATSUNO, Tokyo (JP)

(21) Appl. No.: 19/218,780

(22) Filed: May 27, 2025

(30) Foreign Application Priority Data
Jun. 17, 2024 (JP) 2024-097755

(51) Int. Cl. B60L 15/20; B60K 1/02

(52) U.S. Cl. CPC B60L 15/20; B60K 1/02; B60L 2240/12; B60L 2240/16; B60L 2240/465; B60L 2240/642

(57) ABSTRACT

A vehicle control device for a vehicle includes at least one processor and at least one memory coupled to the processor. The processor is configured to execute processing including: determining a first difference, which represents a difference between rotational angular acceleration of a front axle and that of a rear axle; setting a time constant of a low-pass filter to be a value corresponding to a value of the first difference; determining an estimated value of a gradient of a driving road surface, based on a current value of a rate of change of velocity of the vehicle; and executing first-order lag processing for the estimated value of the gradient by using the low-pass filter having the set time constant and updating the estimated value of the gradient to be the value obtained by executing the first-order lag processing as a currently estimated value of the gradient.

### CROSS-REFERENCE TO RELATED APPLICATIONS

The present application claims priority from Japanese Patent Application No. 2024-097755 filed on Jun. 17, 2024, the entire contents of which are hereby incorporated by reference.

### BACKGROUND

The disclosure relates to a vehicle control device. Japanese Unexamined Patent Application Publication No. 2009-173126 discloses a vehicle that sets an estimated road surface gradient, which is the estimated value of the gradient of a road surface. In this vehicle, if a predetermined condition is satisfied and if the intended torque for driving the vehicle is smaller than a predetermined value, the estimated road surface gradient is set based on the intended torque and the detected acceleration of the vehicle.

### SUMMARY

An aspect of the disclosure provides a vehicle control device used configured to be applied to a vehicle. The vehicle includes a front axle coupled to a front wheel, a rear axle coupled to a rear wheel, a first motor generator configured to drive the front axle to rotate, and a second motor generator configured to drive the rear axle to rotate. The vehicle control device includes at least one processor and at least one memory coupled to the at least one processor. The at least one processor is configured to execute processing including: determining of a first difference, the first difference representing a difference between rotational angular acceleration of the front axle and rotational angular acceleration of the rear axle; setting of a time constant of a low-pass filter to be a value corresponding to a value of the first difference; determining of an estimated value of a gradient of a road surface on which the vehicle is driving, based on a current value of a rate of change of velocity of the vehicle; and executing of first-order lag processing for the estimated value of the gradient by using the low-pass filter having the set time constant and updating of the estimated value of the gradient to be an estimated value obtained by executing the first-order lag processing as a currently estimated value of the gradient.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating the configuration of a vehicle in an embodiment;

FIG. 2 is a flowchart illustrating an operation of a vehicle control device of the embodiment;

FIG. 3 is a flowchart illustrating a procedure of specific gradient estimation processing;

FIG. 4 is a graph for explaining an example of the approach to setting a time constant; and

FIG. 5 is a flowchart illustrating a procedure of specific vehicle velocity estimation processing.

### DETAILED DESCRIPTION

If at least one of the wheels of a vehicle is not skidding while the vehicle is climbing a slope, the rate of change of velocity of the vehicle can be estimated based on the velocity of the wheel which is not skidding. In this situation, the gradient of the slope can be estimated based on the estimated rate of change of velocity and the acceleration in the longitudinal direction of the vehicle detected by a longitudinal acceleration sensor.

However, if, for example, all the four wheels of the vehicle are skidding substantially at the same time while the vehicle is climbing the slope, the velocity of the wheel is not correctly detected as the velocity of the vehicle, thereby making it difficult to estimate a rate of change of velocity of the vehicle based on the wheel velocity. In such a situation, even if the acceleration in the longitudinal direction of the vehicle is detected, it is difficult to estimate the gradient of the driving road, based on the approach using the rate of change of velocity and the longitudinal acceleration of the vehicle.

It is thus desirable to provide a vehicle control device that can appropriately estimate the gradient of a road surface.

An embodiment of the disclosure will be described below in detail with reference to the accompanying drawings. Specific dimensions, materials, and numerical values, for example, discussed in the embodiment are only examples for easy understanding of the disclosure and are not intended to restrict the disclosure unless otherwise stated. In the specification and drawings, elements having substantially the same function or configuration are designated by like reference numeral and an explanation thereof will not be repeated. Elements that are not directly related to the disclosure are not illustrated in the drawings.

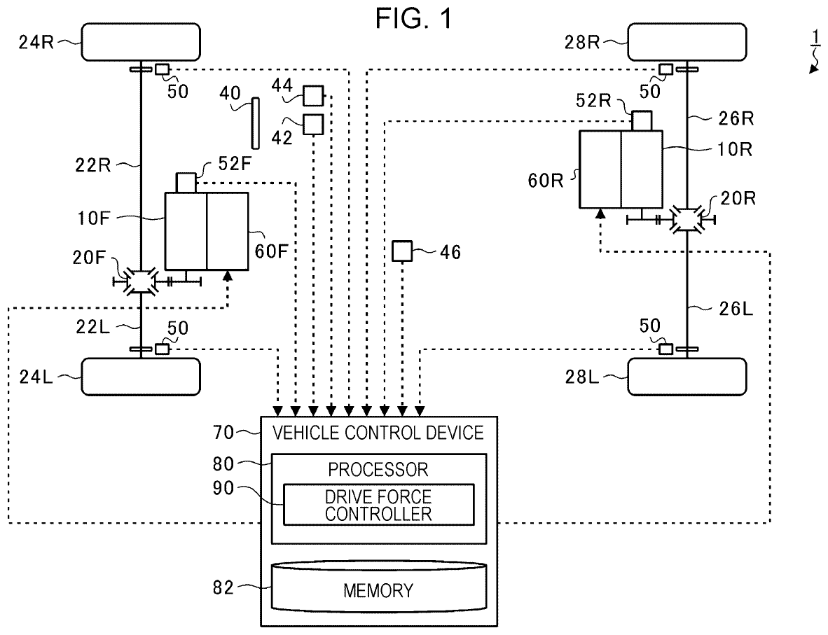

FIG. 1 is a schematic diagram illustrating the configuration of a vehicle 1 in the embodiment. The vehicle 1 is an electric automobile including a first motor generator 10F and a second motor generator 10R as a drive source.

The vehicle 1 also includes a front differential gear 20F, a rear differential gear 20R, a left front axle 22L, a right front axle 22R, a left front wheel 24L, a right front wheel 24R, a left rear axle 26L, a right rear axle 26R, a left rear wheel 28L, and a right rear wheel 28R.

The output shaft of the first motor generator 10F is coupled to the front differential gear 20F. The front differential gear 20F is coupled to the left front wheel 24L via the left front axle 22L and is also coupled to the right front wheel 24R via the right front axle 22R. The front differential gear 20F allows for a difference between the rotation of the left front wheel 24L and that of the right front wheel 24R. In other words, the front differential gear 20F allows for a differential between the left front wheel 24L and the right front wheel 24R.

The output shaft of the second motor generator 10R is coupled to the rear differential gear 20R. The rear differential gear 20R is coupled to the left rear wheel 28L via the left rear axle 26L and is also coupled to the right rear wheel 28R via the right rear axle 26R. The rear differential gear 20R allows for a difference between the rotation of the left rear wheel 28L and that of the right rear wheel 28R. In other words, the rear differential gear 20R allows for a differential between the left rear wheel 28L and the right rear wheel 28R.

For the sake of description, the left front axle 22L and the right front axle 22R may be simply called the front axles collectively, and the left rear axle 26L and the right rear axle 26R may be simply called the rear axles collectively. The left front wheel 24L and the left rear wheel 28L may be collectively called the left wheels, and the right front wheel 24R and the right rear wheel 28R may be collectively called the right wheels. The left front wheel 24L and the right front wheel 24R may be collectively called the front wheels, and the left rear wheel 28L and the right rear wheel 28R may be collectively called the rear wheels. The left front wheel 24L, right front wheel 24R, left rear wheel 28L, and right rear wheel 28R may be simply called the wheels collectively.

For the sake of description, the front differential gear 20F and the rear differential gear 20R may be simply called the differential gears collectively. Each differential gear allows for a differential between the left wheel and the right wheel.

For the sake of description, the first motor generator 10F and the second motor generator 10R may be simply called the motor generators collectively. The first motor generator 10F drives the rotation of the front axles coupled to the front wheels by using electricity of a battery, which is not illustrated. The second motor generator 10R drives the rotation of the rear axles coupled to the rear wheels by using electricity of a battery, which is not illustrated.

The vehicle 1 also includes a steering device 40, a steering angle sensor 42, an accelerator pedal sensor 44, a longitudinal acceleration sensor 46, a wheel velocity sensor 50, a first rotational angle sensor 52F, and a second rotational angle sensor 52R.

The steering device 40 includes a hand-operated steering wheel that can receive the input of a steering operation of a driver who is driving the vehicle 1. The steering device 40 can change the steering angle of the front wheels, which serve as steering wheels, based on the steering operation performed on the hand-operated steering wheel by the driver.

The steering angle sensor 42 detects the steering angle which represents the rotational angle of the hand-operated steering wheel. The accelerator pedal sensor 44 detects the amount by which the accelerator pedal is operated by the driver. The longitudinal acceleration sensor 46 detects the longitudinal acceleration which indicates the acceleration applied in the longitudinal direction of the vehicle 1.

The wheel velocity sensor 50 is provided for each wheel. The wheel velocity sensor 50 detects the velocity of the associated wheel. The wheel velocity represents the rotational speed of the wheel.

The first rotational angle sensor 52F detects the rotational angle of the first motor generator 10F. The second rotational angle sensor 52R detects the rotational angle of the second motor generator 10R.

The vehicle 1 also includes a first motor driver 60F, a second motor driver 60R, and a vehicle control device 70. That is, the vehicle control device 70 of the embodiment is provided in the vehicle 1.

The first motor driver 60F operates the first motor generator 10F under the control of the vehicle control device 70. The second motor driver 60R operates the second motor generator 10R under the control of the vehicle control device 70.

Each of the first and second motor drivers 60F and 60R may include an inverter and a gate drive circuit, for example. The inverter includes a switching element and converts DC power of a battery to AC power and supplies the converted AC power to the corresponding motor generator. The gate drive circuit supplies a drive signal to the gate of the switching element of the inverter to turn ON or OFF the switching element, in response to the reception of a control signal from the vehicle control device 70.

The vehicle control device 70 includes one or multiple processors 80 (hereinafter simply called the processor 80) and one or multiple memories 82 (hereinafter simply called the memory 82) coupled to the processor 80. The memory 82 includes a read only memory (ROM) storing a program, for example, and a random access memory (RAM) which serves as a work area. The processor 80 controls the individual elements of the vehicle 1 in cooperation with the program stored in the memory 82.

For example, the processor 80 of the vehicle control device 70 can serve as a drive force controller 90 by executing the program.

For instance, the drive force controller 90 determines first output torque of the first motor generator 10F and second output torque of the second motor generator 10R, based on the operation amount of the accelerator pedal detected by the accelerator pedal sensor 44. The drive force controller 90 outputs a control signal indicating the first output torque to the first motor driver 60F so as to control the rotation of the first motor generator 10F. The drive force controller 90 also outputs a control signal indicating the second output torque to the second motor driver 60R so as to control the rotation of the first motor generator 10R.

To determine the first output torque of the first motor generator 10F and the second output torque of the second motor generator 10R, the drive force controller 90 may estimate the gradient of the surface of the road on which the vehicle 1 is running and the running velocity of the vehicle 1.

For example, the situation where the vehicle 1 is climbing a slope is assumed now. If at least one of the wheels of the vehicle 1 is not skidding while the vehicle 1 is climbing the slope, the rate of change of velocity of the vehicle 1 can be estimated based on the velocity of the wheel which is not skidding. The rate of change of velocity of the vehicle 1 represents a temporal change in the velocity of the vehicle 1 and is the dimension of the acceleration. The velocity of the vehicle 1 can be estimated based on the rate of change of velocity of the vehicle 1. If at least one of the wheels of the vehicle 1 is not skidding while the vehicle 1 is climbing the slope, the gradient of the slope can be estimated based on the estimated rate of change of velocity and the longitudinal acceleration detected by the longitudinal acceleration sensor 46.

However, if, for example, all the four wheels of the vehicle 1 are skidding substantially at the same time while the vehicle 1 is climbing the slope, the velocity of the wheel is not correctly detected as the velocity of the vehicle, thereby making it difficult to appropriately estimate a rate of change of velocity of the vehicle 1 based on the wheel velocity. In such a situation, even if the longitudinal acceleration is detected, it is difficult to estimate the gradient of the driving road based on the approach using the rate of change of velocity and the longitudinal acceleration of the vehicle 1, thereby failing to estimate the velocity of the vehicle 1. Failing to appropriately estimate the rate of change of velocity of the vehicle 1 also makes it difficult to estimate the velocity of the vehicle 1.

To address this issue, if, at least, all the four wheels are substantially skidding at the same time, the vehicle control device 70 of the embodiment estimates the gradient of a road surface and the velocity of the vehicle 1 by using the following specific method.

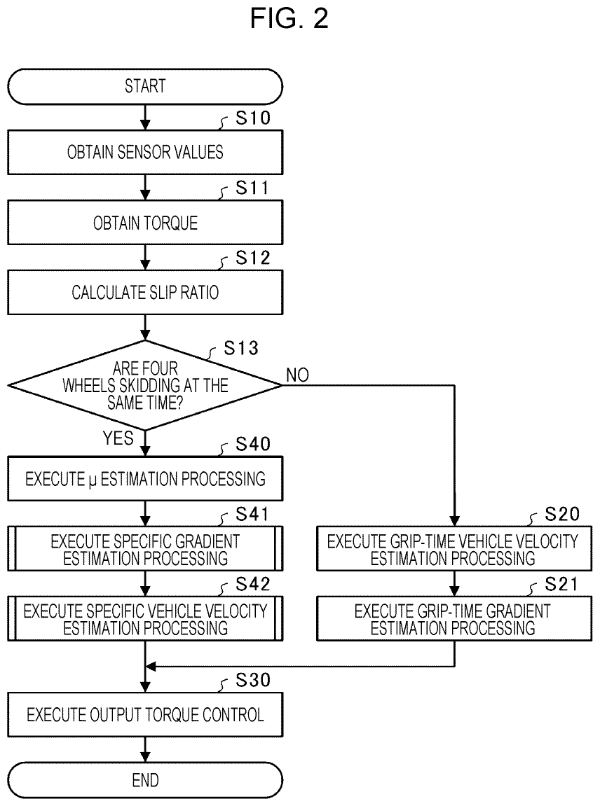

FIG. 2 is a flowchart illustrating an operation of the vehicle control device 70 of the embodiment. The drive force controller 90 of the vehicle control device 70 repeatedly executes the processing illustrated in the flowchart of FIG. 2 at every predetermined execution timing at regular intervals.

Since the processing illustrated in FIG. 2 is repeatedly executed at regular intervals, for the sake of description, values determined at one previous execution timing may be called the previous values. The determined values are stored in the memory 82. The previous values stored in the memory 82 can be read from the memory 82 and be used.

In step S10, when a predetermined execution timing has reached, the drive force controller 90 obtains the values detected by the individual sensors. For example, the drive force controller 90 may obtain the longitudinal acceleration from the longitudinal acceleration sensor 46 and the wheel velocities of the vehicle 1 from the wheel velocity sensors 50. The drive force controller 90 may also obtain the rotational angle of the first motor generator 10F from the first rotational angle sensor 52F and the rotational angle of the second motor generator 10R from the second rotational angle sensor 52R.

Then, in step S11, the drive force controller 90 obtains or determines torque of the first motor generator 10F and that of the second motor generator 10R. For example, the drive force controller 90 may determine the current torque of the first motor generator 10F based on AC power supplied from the first motor driver 60F to the first motor generator 10F and determine the current torque of the second motor generator 10R based on AC power supplied from the second motor driver 60R to the second motor generator 10R.

Then, in step S12, the drive force controller 90 calculates the slip ratio of each of the four wheels according to the following expression (1):

$${λ}_{n} = \frac{{ω}_{n} \cdot {R}_{tire} - V}{V} \qquad ( 1 )$$

where λₙ is a slip ratio of the wheel, ωₙ is the velocity of the individual wheel obtained from the associated wheel velocity sensor 50, Rₜᵢᵣₑ is the tire size, and V is the velocity of the vehicle 1. For the velocity of the vehicle 1, the previous value stored in the memory 82 can be used. Subsequently, in step S13, the drive force controller 90 determines whether all the four wheels are currently skidding substantially at the same time. For example, the drive force controller 90 may determine that the four wheels are skidding substantially at the same time if, for example, the slip ratios of the four wheels calculated in step S12 are all greater than a preset value.

If it is found that not all the four wheels are skidding substantially at the same time (NO in step S13), in step S20, the drive force controller 90 executes grip-time vehicle velocity estimation processing. The grip-time vehicle velocity estimation processing is to determine the estimated value of the velocity of the vehicle 1 when the wheels maintain their grip on the road surface (hereinafter such a situation will be called “at the time of maintaining grip”).

In one example, the drive force controller 90 determines the rate of change of velocity of the vehicle 1 at the time of maintaining grip according to the following expression (2):

$${A}_{Grip} = \frac{{dV}_{wGrip}}{dt} \qquad ( 2 )$$

where A_{Grip} is the rate of change of velocity of the vehicle 1, which is the dimension of the acceleration, at the time of maintaining grip, V_{wGrip} is the velocity of the wheel at the time of maintaining grip, and dV_{wGrip}/dt is the time derivative of the wheel velocity at the time of maintaining grip. For V_{wGrip}, the wheel velocity obtained from the wheel velocity sensor 50 can be used. To find V_{wGrip}, any of the wheels which is not skidding can be used.

Based on the rate of change of velocity at the time of maintaining grip, the drive force controller 90 determines the estimated value of the velocity of the vehicle 1 according to the following expression (3):

$$V = Previous value of V + {A}_{Grip} \cdot Δ t \qquad ( 3 )$$

where V is the estimated value of the velocity of the vehicle 1, the previous value of V is the value of the previously estimated velocity of the vehicle 1, A_{Grip} is the rate of change of velocity of the vehicle 1 at the time of maintaining grip, which is found in expression (2), and Δt is a calculation cycle, which represents a cycle from the time point of the previous calculation of the estimated value of the velocity of the vehicle 1 until the current time. As the previous value of V, the value of the previously estimated velocity of the vehicle 1 stored in the memory 82 can be used.

After step S20, in step S21, the drive force controller 90 executes grip-time gradient estimation processing. The grip-time gradient estimation processing is to determine the estimated value of the gradient of the road surface on which the vehicle 1 is driving (hereinafter may simply be called the driving road surface) at the time of maintaining grip. In one example, based on the rate of change of velocity of the vehicle 1 at the time of maintaining grip, the drive force controller 90 determines the estimated value of the gradient according to the following expression (4):

$$θ = {sin}^{- 1} ( \frac{a - {A}_{Grip}}{g} ) \qquad ( 4 )$$

where θ is the estimated value of the gradient, A_{Grip} is the rate of change of velocity of the vehicle 1 at the time of maintaining grip, which is found in expression (2), a is the longitudinal acceleration obtained by the longitudinal acceleration sensor 46, g is the gravitational acceleration, and sin-1 is the inverse sine function.

After step S21, in step S30, the drive force controller 90 performs output torque control for the first motor generator 10F and the second motor generator 10R. In step S30, the drive force controller 90 may determine the output torque by using the estimated value of the velocity of the vehicle 1 calculated in step S20 and the estimated value of the gradient calculated in step S21.

If it is determined in step S13 that all the four wheels are skidding substantially at the same time (YES in step S13), the drive force controller 90 proceeds to step S40.

In step S40, the drive force controller 90 executes u estimation processing for determining the estimated value of the friction coefficient of the driving road surface. In the u estimation processing, the drive force controller 90 calculates the estimated value of the friction coefficient of the driving road surface according to the following expression (5):

$$μ = \frac{1}{1 + {T}_{μ} \cdot S} \cdot \frac{a}{g} \qquad ( 5 )$$

where μ is the estimated value of the friction coefficient of the driving road surface, which is the value after a low-pass filter has executed first-order lag processing, a is the longitudinal acceleration obtained by the longitudinal acceleration sensor 46, g is the gravitational acceleration, a/g is the friction coefficient of the driving road surface, which is the value before the low-pass filter executes first-order lag processing, and 1/(1+T_{μ}·S) is a transfer function of the low-pass filter, which is applied to the friction coefficient of the driving road surface. In the transfer function, Tu is a time constant, and S is the Laplace operator.

After step S40, in step S41, the drive force controller 90 executes specific gradient estimation processing. The specific gradient estimation processing is to determine the estimated value of the gradient of the driving road surface when all the four wheels are skidding substantially at the same time. Executing the specific gradient estimation processing makes it possible to appropriately determine the estimated value of the gradient even when the four wheels are skidding substantially at the same time. The specific gradient estimation processing will be discussed later.

After step S41, in step S42, the drive force controller 90 executes specific vehicle velocity estimation processing. The specific vehicle velocity estimation processing is to determine the estimated value of the velocity of the running vehicle 1 when all the four wheels are skidding substantially at the same time. Executing the specific vehicle velocity estimation processing makes it possible to appropriately determine the estimated value of the velocity of the vehicle 1 even when the four wheels are skidding substantially at the same time. The specific vehicle velocity estimation processing will be discussed later.

After step S42, in step S30, the drive force controller 90 performs output torque control for the first motor generator 10F and the second motor generator 10R. In step S30, the drive force controller 90 may determine the output torque by using the estimated value of the friction coefficient of the road surface calculated in step S40, the estimated value of the gradient calculated in step S41, and the estimated value of the velocity of the vehicle 1 calculated in step S42. Then, the drive force controller 90 is able to determine the output torque that allows the vehicle 1 to recover from the skidding of the wheels.

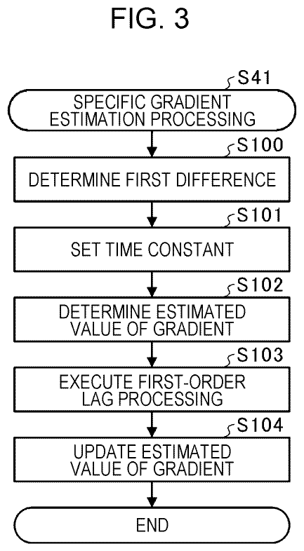

FIG. 3 is a flowchart illustrating a procedure of specific gradient estimation processing in step S41. When the specific gradient estimation processing is started, in step S100, the drive force controller 90 determines a first difference, which represents a difference between the rotational angular acceleration of the front axles and that of the rear axles, according to the following expression (6):

$$Δ = \vert {α}_{f} - {α}_{r} \vert \qquad ( 6 )$$

where Δ is the first difference, which represents a difference between a change of velocity of the front wheels coupled to the front axles and that of the rear wheels coupled to the rear axles, of is the rotational angular acceleration of the front axles, which represents a change of velocity of the front wheels, and αᵣ is the rotational angular acceleration of the rear axles, which represents a change of velocity of the rear wheels.

For example, the drive force controller 90 may determine the rotational angular acceleration α_{f} of the front axles by calculating the average of the wheel velocity (rotational angular velocity) detected by the wheel velocity sensor 50 of the left front wheel 24L and that detected by the wheel velocity sensor 50 of the right front wheel 24R and by then differentiating the resulting average value with respect to time. The drive force controller 90 may alternatively determine the rotational angular acceleration α_{f} of the front axles by time-differentiating the rotational angle obtained from the first rotational angle sensor 52F of the first motor generator 10F. The drive force controller 90 may determine the rotational angular acceleration αᵣ of the rear axles by calculating the average of the wheel velocity (rotational angular velocity) detected by the wheel velocity sensor 50 of the left rear wheel 28L and that detected by the wheel velocity sensor 50 of the right rear wheel 28R and by then differentiating the resulting average value with respect to time. The drive force controller 90 may alternatively determine the rotational angular acceleration αᵣ of the rear axles by time-differentiating the rotational angle obtained from the second rotational angle sensor 52R of the second motor generator 10R. The drive force controller 90 subtracts the rotational angular acceleration αᵣ of the rear axles from the rotational angular acceleration α_{f} of the front axles and sets the absolute value of the resulting subtracted value to be the first difference.

Then, in step S101, the drive force controller 90 sets the time constant T_{θ} of the low-pass filter, which is used to determine the estimated value of the gradient, to be a value corresponding to the first difference Δ determined in step S100. λₙ example of the approach to setting the time constant T_{θ} is as follows.

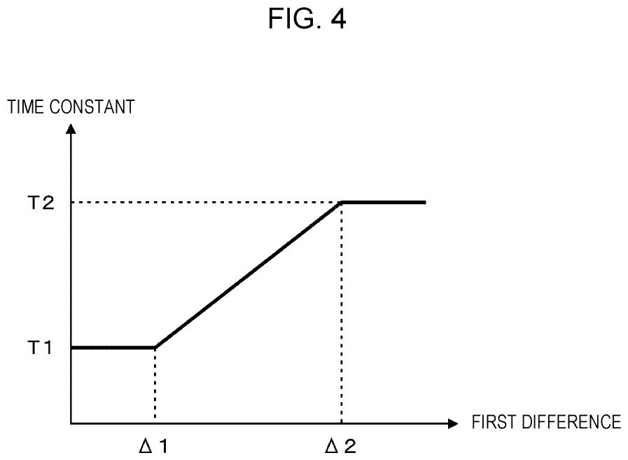

FIG. 4 is a graph for explaining an example of the approach to setting the time constant. As illustrated in FIG. 4, when the first difference Δ is a predetermined first value 41, the drive force controller 90 sets the time constant T_{θ} to be a predetermined first time constant T1. When the first difference Δ is a second value Δ2, which is greater than the first value Δ1, the drive force controller 90 sets the time constant T_{θ} to be a second time constant T2, which is greater than the first time constant T1.

As is seen from the range between the first value Δ1 and the second value Δ2 in FIG. 4, the drive force controller 90 may set the time constant T_{θ} to be a greater value as the first difference Δ is larger.

The relationship between the first difference Δ and the time constant T_{θ}, such as that in FIG. 4, may be prestored in the memory 82.

In the example in FIG. 4, in the range between the first value Δ1 and the second value Δ2, the time constant T_{θ} is continuously changed in proportion to the change of the first difference Δ. However, the relationship between the first difference Δ and the time constant T_{θ} is not limited to this example. For instance, the time constant T_{θ} may be changed in a curved line or progressively in response to the change of the first difference Δ.

Referring back to FIG. 3, after step S101, in step S102, the drive force controller 90 determines the estimated value of the gradient of the driving road surface, based on the current value of the rate of change of velocity of the vehicle 1. In one example, the drive force controller 90 calculates the estimated value of the gradient according to the following expression (7):

$$Θ = {sin}^{- 1} ( \frac{\frac{{T}_{act}}{m \cdot {R}_{tire}} - {A}_{s}}{g} ) \qquad ( 7 )$$

where Θ θ is the estimated value of the gradient to be determined in step S102, g is the gravitational acceleration, sin-1 is the inverse sine function, Aₛ is the current value of the rate of change of velocity of the vehicle 1, which is calculated according to expression (10), m is the mass of the vehicle 1, Rₜᵢᵣₑ is the tire size, and Tact is the effective driving torque, which is calculated according to the following expression (8).

To determine the estimated value Θ of the gradient in expression (7), the drive force controller 90 calculates the effective driving torque T_{act} in expression (7) according to the following expression (8):

$${T}_{act} = {T}_{wMG} - {T}_{brk} - {I}_{w} \cdot {α}_{s} \qquad ( 8 )$$

where T_{wMG} is the wheel torque of the motor generators, T_{brk} is the brake torque, I_{w} is the total rotational inertia of the drive system, such as that of the wheels and that of the motor generators in terms of the rotational inertia of the front and rear axles, and αₛ is the surplus rotational angular acceleration, which is calculated according to expression (9). As represented by expression (8), the effective driving torque T_{act} is calculated by subtracting the torque consumed for the idling of the driving wheels from the driving torque of the motor generators.

To determine the effective driving torque T_{act} in expression (8), the drive force controller 90 calculates the surplus rotational angular acceleration αₛ in expression (8) according to the following expression (9):

$${α}_{s} = α - \frac{{A}_{s}}{{R}_{tire}} \qquad ( 9 )$$

where a is the rotational angular acceleration of the drive system, Rₜᵢᵣₑ is the tire size, and Aₛ is the current value of the rate of change of velocity of the vehicle 1, which is calculated according to expression (10).

To calculate the above-described expression (9), the drive force controller 90 calculates the current value Aₛ of the rate of change of velocity of the vehicle 1 in expression (9) according to the following expression (10):

$${A}_{s} = a - g \cdot sin ( Previous value of θ ) \qquad ( 10 )$$

where a is the longitudinal acceleration obtained by the longitudinal acceleration sensor 46, g is the gravitational acceleration, and the previous value of θ is the previously estimated value of the gradient. As the previous value of θ, the previously estimated value of the gradient stored in the memory 82 can be used. In this manner, the current value Aₛ of the rate of change of velocity of the vehicle 1 can be calculated based on the previously estimated value e of the gradient and the longitudinal acceleration a obtained by the longitudinal acceleration sensor 46.

The current value Aₛ of the rate of change of velocity of the vehicle 1 calculated by expression (10) can be used as Aₛ in expression (9) and also as Aₛ in expression (7).

The drive force controller 90 determines the estimated value Θ of the gradient in expression (7) from the above-described expressions (7) through (10). Strictly speaking, the estimated value Θ of the gradient is different from the estimated value θ of the gradient. In the specific gradient estimation processing, the estimated value θ of the gradient is determined from the estimated value Θ of the gradient, which will be discussed below.

After step S102, in step S103, for the estimated value Θ determined in step S102, the drive force controller 90 executes first-order lag processing by using the low-pass filter having the time constant T_{θ} set in step S101. In one example, the drive force controller 90 executes first-order lag processing according to the following expression (11):

$$θ = \frac{1}{1 + {T}_{θ} \cdot S} \cdot Θ \qquad ( 11 )$$

where θ is the estimated value of the gradient obtained as a result of the low-pass filter executing first-order lag processing, Θθ is the estimated value of the gradient determined in step S102, which has not been subjected to first-order lag processing, and 1/(1+T_{θ}·S) is a transfer function of the low-pass filter, which is applied to the estimated value Θ of the gradient. In the transfer function, T_{θ} is the time constant, which has been set in step S101, and S is the Laplace operator.

After step S103, in step S104, the drive force controller 90 updates the estimated value of the gradient by storing the estimated value θ of the gradient obtained by executing first-order lag processing in step S103 in the memory 82 as the currently estimated value of the gradient. The drive force controller 90 then completes the specific gradient estimation processing. The updated estimated value of the gradient can be used as the previously estimated value of the gradient at the execution timing of the next processing.

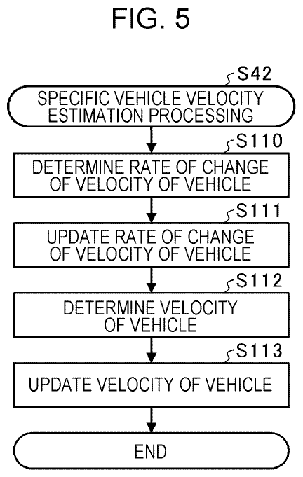

FIG. 5 is a flowchart illustrating a procedure of specific vehicle velocity estimation processing in step S42. The specific vehicle velocity estimation processing is started after step S104 in which the estimated value of the gradient is updated in the specific gradient estimation processing.

When the specific vehicle velocity estimation processing is started, in step S110, the drive force controller 90 determines the rate of change of velocity of the vehicle 1, based on the currently estimated value of the gradient updated in step S104 and the longitudinal acceleration obtained by the longitudinal acceleration sensor 46. In one example, the drive force controller 90 calculates the rate of change of velocity of the vehicle 1 according to the following expression (12):

$$A = a - g \cdot sin ( Latest value of θ ) \qquad ( 12 )$$

where A is the rate of change of velocity of the vehicle 1 in which the currently estimated value of the gradient updated in step S104 is reflected, a is the longitudinal acceleration obtained by the longitudinal acceleration sensor 46, g is the gravitational acceleration, and the latest value of θ is the currently estimated value of the gradient updated in step S104, that is, the latest estimated value of the gradient.

After step S110, in step S111, the drive force controller 90 updates the estimated value of the rate of change of velocity of the vehicle 1 by storing the rate A of change of velocity calculated in step S110 in the memory 82 as the current value of the rate of change of velocity of the vehicle 1. The updated rate of change of velocity of the vehicle 1 can be used as the previous value of the rate of change of velocity of the vehicle 1 at the execution timing of the next processing.

After step S111, in step S112, the drive force controller 90 determines the current value of the velocity of the vehicle 1, based on the current value of the rate of change of velocity of the vehicle 1 updated in step S111. In one example, the drive force controller 90 calculates the current value of the velocity of the vehicle 1 according to the following expression (13):

$$V = Previous value of V + Latest value of A \cdot Δ t \qquad ( 13 )$$

where V is the currently estimated value of the velocity of the vehicle 1, the previous value of V is the previously estimated value of the velocity of the vehicle 1, the latest value of A is the current value of the rate of change of velocity of the vehicle 1 updated in step S111, that is, the latest value of the rate of change of velocity of the vehicle 1, and Δt is a calculation cycle, which represents a cycle from the time point of the previous calculation of the estimated value of the velocity of the vehicle 1 until the current time. As the previous value of V, the previous value of the velocity of the vehicle 1 stored in the memory 82 can be used.

After step S112, in step S113, the drive force controller 90 updates the estimated value of the velocity of the vehicle 1 by storing the estimated value V of the velocity calculated in step S112 in the memory 82 as the currently estimated value of the velocity of the vehicle 1. The drive force controller 90 then completes the specific vehicle velocity estimation processing.

As described above, in the vehicle 1, a motor generator for driving the rotation of the front wheels and a motor generator for driving the rotation of the rear wheels are separately provided. It can thus be presumed that the velocity of the front wheels and that of the rear wheels are changed separately in response to a change of the friction coefficient of the road surface. For example, when the vehicle 1 is passing through a slippery road surface, the velocity of the front wheels and that of the rear wheels are changed at different timings in response to a change of the situation of the road surface. For example, the front wheels skid first, and then, the rear wheels skid.

It can be assumed that a change of the gradient of the driving road surface substantially equally changes the velocity of the front wheels and that of the rear wheels. Based on the above-described assumption, when the velocity of the front wheels and that of the rear wheels are substantially the same, in other words, when the first difference Δ is relatively small, it can be presumed that the gradient of the driving road surface is changing.

As discussed above, in the setting of the time constant T_{θ}, the drive force controller 90 sets the time constant T_{θ} to be a relatively small first time constant T1 when the first difference Δ is the first value Δ1, which is a relatively small value. When the time constant T_{θ} is a relatively small value, the amount of delay in first-order lag processing becomes small, which comparatively increases the changing speed of the estimated value θ of the gradient after first-order lag processing is executed. In other words, the updating speed of the estimated value θ of the gradient is relatively increased.

In a situation where the gradient of the driving road surface is likely to be changing, the changing speed of the estimated value θ of the gradient can be relatively quickened, thereby making it possible to increase the updating speed of the estimated value θ of the gradient in response to the changing gradient. That is, the accuracy in determining the estimated value θ of the gradient can be improved.

When the updating speed of the estimated value θ of the gradient is quickened, the term of the sine wave component “g·sign (the latest value of θ)” representing the estimated value of the gradient in the above-described expression (12) more quickly follows the actual longitudinal acceleration a detected by the longitudinal acceleration sensor 46. That is, in this case, the rate A of change of velocity of the vehicle 1 approaches a relatively small value, and it can be presumed that there is almost no change in the velocity of the vehicle 1 although the estimated value θ of the gradient is changing. This makes it possible to decrease a deviation of the estimated value A of the rate of change of velocity from the actual rate of change of velocity of the vehicle 1.

Using the vehicle control device 70 of the embodiment can improve the accuracy in determining the estimated value θ of the gradient. The vehicle control device 70 can also improve the accuracy in determining the estimated value V of the velocity of the vehicle 1, which is determined based on the estimated value A of the rate of change of velocity of the vehicle 1.

In contrast, for example, when the velocity of the front wheels and that of the rear wheels are considerably different from each other, that is, when the first difference Δ is relatively large, it can be presumed that a change of the gradient of the driving road surface is relatively small and a change of the road surface condition is relatively large.

As discussed above, in the setting of the time constant T_{θ}, the drive force controller 90 sets the time constant T_{θ} to be a relatively large second time constant T2 when the first difference Δ is the second value 42, which is a relatively large value. When the time constant T_{θ} is a relatively large value, the amount of delay in first-order lag processing becomes large, which comparatively decreases the changing speed of the estimated value θ of the gradient after first-order lag processing is executed. In other words, the updating speed of the estimated value θ of the gradient is comparatively decreased.

In a situation where a change of the gradient of the driving road surface is likely to be relatively small, even though the updating speed of the estimated value θ of the gradient is relatively low, the accuracy in determining the estimated value θ of the gradient is not degraded.

When the updating speed of the estimated value θ of the gradient is relatively decreased, the variation in the estimated value θ of the gradient becomes relatively small. Hence, the term of the sine wave component “g·sign (the latest value of θ)” representing the estimated value of the gradient in the above-described expression (12) becomes different by a greater amount from the actual longitudinal acceleration a detected by the longitudinal acceleration sensor 46. That is, in this case, the rate A of change of velocity of the vehicle 1 becomes a relatively large value, and it can be presumed that the gradient is not considerably changing, but the velocity of the vehicle 1 is changing. Then, the estimated value A of the rate of change of velocity of the vehicle 1 is also changed in response to the actual rate of change of velocity of the vehicle 1, thereby making it possible to decrease a deviation of the estimated value A from the actual rate of change of velocity of the vehicle 1.

From this viewpoint, too, using the vehicle control device 70 of the embodiment can improve the accuracy in determining the estimated value V of the velocity of the vehicle 1, which is determined based on the estimated value A of the rate of change of velocity of the vehicle 1, substantially without lowering the accuracy in determining the estimated value θ of the gradient.

As described above, the vehicle control device 70 of the embodiment determines a first difference, which represents a difference between the rotational angular acceleration of the front axles and that of the rear axles. The vehicle control device 70 of the embodiment also sets a time constant of a low-pass filter to be a value corresponding to the value of the first difference. The vehicle control device 70 of the embodiment also determines the estimated value of the gradient of the road surface on which the vehicle 1 is driving, based on the current value of the rate of change of velocity of the vehicle 1. The vehicle control device 70 of the embodiment also executes first-order lag processing for the estimated value of the gradient by using the low-pass filter having the set time constant and updates the estimated value of the gradient to be the value obtained by executing the first-order lag processing as the currently estimated value of the gradient.

Since the vehicle control device 70 of the embodiment sets the time constant of the low-pass filter, which is applied to the estimated value of the gradient, to be a value corresponding to the first difference, the updating speed of the estimated value of the gradient can be controlled appropriately. Hence, using the vehicle control device 70 of the embodiment can improve or substantially maintain the accuracy in determining the estimated value of the gradient.

As a result, by using the vehicle control device 70 of the embodiment, even under a situation where all the four wheels of a vehicle are skidding substantially at the same time while the vehicle is climbing a slope, the gradient of the road surface can be estimated appropriately.

Additionally, the vehicle control device 70 of the embodiment can improve the accuracy in determining the estimated value of the velocity of a vehicle, as well as the accuracy in determining the estimated value of the gradient.

The disclosure has been discussed through illustration of the embodiment with reference to the accompanying drawings. However, the disclosure is not limited to the embodiment. Obviously, many modifications and variations will be apparent to practitioners skilled in the art without departing from the scope and spirit of the disclosure and it is understood that such modifications and variations are also encompassed in the technical scope of the disclosure.

The processing operations described in the specification may not necessarily be executed in chronological order described in the flowcharts and may be executed in parallel or may include an operation executed by a sub-routine.

The vehicle control device 70 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the vehicle control device 70 including the processor 80, the drive force controller 90, and the memory 82. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A vehicle control device configured to be applied to a vehicle, the vehicle comprising a front axle coupled to a front wheel, a rear axle coupled to a rear wheel, a first motor generator configured to drive the front axle to rotate, and a second motor generator configured to drive the rear axle to rotate,
the vehicle control device comprising:
at least one processor; and
at least one memory coupled to the at least one processor,
wherein the at least one processor is configured to execute processing comprising
determining of a first difference, the first difference representing a difference between rotational angular acceleration of the front axle and rotational angular acceleration of the rear axle,
setting of a time constant of a low-pass filter to be a value corresponding to a value of the first difference,
determining of an estimated value of a gradient of a road surface on which the vehicle is driving, based on a current value of a rate of change of velocity of the vehicle, and
executing of first-order lag processing for the estimated value of the gradient by using the low-pass filter having the set time constant and updating of the estimated value of the gradient to be an estimated value obtained by executing the first-order lag processing as a currently estimated value of the gradient.

2. The vehicle control device according to claim 1, wherein, in the setting of the time constant,
when the first difference is a predetermined first value, the time constant is set to be a predetermined first time constant, and
when the first difference is a second value larger than the first value, the time constant is set to be a second time constant larger than the first time constant.

3. The vehicle control device according to claim 1, wherein, in the setting of the time constant,
as the first difference is larger, the time constant is set to be a larger value.

4. The vehicle control device according to claim 1, wherein
the at least one processor is configured to execute processing comprising
making a determination regarding whether the front wheel and the rear wheel are all skidding, and
the setting of the time constant is executed when a result of the determination indicates that the front wheel and the rear wheel are all skidding.

5. The vehicle control device according to claim 1, further comprising:
an acceleration sensor configured to detect acceleration in a longitudinal direction of the vehicle,
wherein the at least one processor is configured to execute processing comprising
after the updating of the estimated value of the gradient, determining of the rate of change of the velocity of the vehicle, based on the currently estimated value of the gradient and the acceleration obtained by the acceleration sensor, and updating of the rate of change of the velocity to the determined rate of change of the velocity as a current value of the rate of change of the velocity of the vehicle, and
determining of a current value of the velocity of the vehicle, based on the updated current value of the rate of change of the velocity of the vehicle.
